(19) United States
(12) Patent Application Publication
(10) Pub. No.: US 2024/0237159 A9
(43) Pub. Date: Jul. 11, 2024

(54) SYSTEMS AND METHODS FOR MAGNETIC HEAT INDUCTION AND EXCHANGE TO MOBILE STREAMS OF MATTER

(71) Applicant: INDUCTION FOOD SYSTEMS, INC., Raleigh, NC (US)

(72) Inventors: George SADLER, Raleigh, NC (US); Francesco AIMONE, Raleigh, NC (US); Edward LUKAWSKI, Gilberts, IL (US); Michael CHAPMAN, Chicago Heights, IL (US)

(73) Assignee: INDUCTION FOOD SYSTEMS, INC., Raleigh, NC (US)

(21) Appl. No.: 18/278,223

(22) PCT Filed: Feb. 22, 2022
(86) PCT No.: PCT/US2022/017316

§ 371 Date: Aug. 22, 2023

Related U.S. Application Data
(60) Provisional application No. 63/152,145, filed on Feb. 22, 2021.

(51) Int. Cl. H05B 6/10; H05B 6/04; H05B 6/06; H05B 6/40

(52) U.S. Cl. CPC H05B 6/108; H05B 6/04; H05B 6/06; H05B 6/40

(57) ABSTRACT

The disclosure describes a magnetic induction heating system for viscous and thermally sensitive process streams. The magnetic induction system provides an industrial heating alternative to steam by providing gentle and uniform heating with a high degree of temperature uniformity and stability. The magnetic induction heating system for viscous and thermally sensitive process streams generally includes an induction system that provides gentle heating through a combination of coil design, coupled with a high efficiency heat exchange element capable of gentle heating and through electronic control is such a way unprecedented stability, safety, uniformity, compactness, energy control, and efficiency are achieved.

### BACKGROUND

This application claims priority to U.S. Provisional Patent Application Ser. No. 63/152,145, filed Feb. 22, 2021; the disclosure of which is incorporated herein by reference in its entirety.

The present disclosure relates generally to magnetic induction heating and more specifically to a device for magnetic heat induction and heat exchange to mobile streams of matter. More specifically, and without limitation, disclosed embodiments relate generally to magnetic induction heating of flowing process streams, and may relate to a magnetic induction heating system for viscous and thermally sensitive process streams.

### SUMMARY

The embodiments of the present disclosure include systems and methods for magnetic heat induction and exchange to mobile streams of matter. Disclosed embodiments provide an industrial heating alternative that provides gentle, uniform heating, with a high degree of temperature uniformity and stability.

Disclosed embodiments provide an induction heating system for processing thermally labile and/or viscous process streams. The magnetic induction system includes a carefully crafted heat generation and exchange system. The systems and methods described herein provide gentle heating results through careful coil design and through a heat generation and exchange element that provide gentle heating with unprecedented stability, safety, uniformity, compactness, energy control, and efficiency compared to previous heating solutions, including steam heating.

Embodiments of the present disclosure provide a magnetic induction heating system. The magnetic induction heating system may include a tube having an inlet that receives a gaseous, fluid, or solid material, at least one inductively-heated heat exchange element positioned within the tube, at least one coil or other flux-inducing conductor wrapped around or otherwise addressing the tube, a power source delivering an alternating current to the at least one coil at a frequency tailored the architecture of the system and the process stream, with the alternating current inducing a current in the heat exchange element to produce heat, wherein the heat from the heat exchange element is transferred to the material in the process stream.

In some embodiments, the system parameters may be manipulated to process material of any thermal sensitivity. System parameters may be manipulated to process any material capable of conveyance and of any viscosity

In some embodiments, the coil has a plurality of adjustable parameters including the number of turns of the coil, the length of the coil bundle, the diameter of the coil, and the number of coils implemented in the system, wherein such parameters can be strategically designed for optimal system and process stream treatment.

In some embodiments, the heat exchange element is constructed to produce even heating by providing patterns containing a 4-skin depth (a) width bounded by regions of high electrical resistance. The heat exchange element forms at least one of the following configurations: a spiral, a waffle disk, a perforated disk, a plate stack with openings offset in each consecutive plate or other structures conforming to the 4-skin depth convention. HEX design may be custom-tailored to accommodate the physical or spatial properties of the heated medium so that repeating subunits of the HEX allow for a broad range of viscosities 0 to 500,000 cps or for the heating of particulate matter typically up to 1-5 cm in longest dimension or for maximum surface area.

Adjustable HEX design parameters include, but are not limited to: the overall diameter of the processing tube, which ranges from 1 cm-365 cm; the spacing between plates or structures, which can range between 0.5 cm-60 cm; the amount of cross-sectional area in the tube occupied by the heat exchanging structure, which ranges between 10%-99%; the angle at which adjacent subunits are positioned with respect to each other or the angle at which the heat exchanging structure is oriented in relation to the flow of the product stream, which range from 0° (parallel) −90° (perpendicular).

Other adjustable HEX design parameters include, but are not limited to: minimum gap between repeating 3-D motifs in HEX design; the HEX material composition; HEX surface finishes, coatings or patterns; tortuosity-inducing obstacles and flow channels.

HEX structures can be supported inside the processing tube in various manners. In some embodiments they are affixed to each other with a spacing element between them, or to a common support structure that occupies the entire length of the heating zone, or welded or otherwise affixed to the tube wall for mechanical stability. At times they are attached to a shared support structure or structures and that shared support structure or structures are affixed or otherwise made stable by welding, clamping, bolting, or other mechanical means. At times the inner diameter of the tube may contain a welded or otherwise affixed component, like a raised bead or knob, to assist in stabilizing the HEX inside the tube. At times the HEX remains in place as the result of friction between the heat exchanging elements and the inner diameter of the tube wall.

In general, low viscosity, particulate-free, thermally sensitive streams favor compact HEX design and viscous, particulate-containing or thermally stable streams incline to loose HEX spacing and wide tube diameters.

In some embodiments suitable to processing laminar flow streams, additional structures may be added that promote mixing or stirring of the material between the primary heat exchanging structures. Additional mixing structures are primarily used when processing laminar flow streams. Mixing and stirring is driven by hydrodynamic forces as the material passes through these structures and subunits as a result of varying velocity in the fluid flow, dividing flow streams, or other related hydrodynamic mechanism.

In some embodiments, the heat exchange element(s) may be moveable within the tube either by passive hydrodynamic forces or through mechanically induced stirring. The heat exchange element(s) may rotate either by hydrodynamic forces or through mechanically induced mixing to increase heat exchange and, where needed, to assist to in conveying the process stream through the tube.

In some embodiments, the tube comprises 304 Stainless Steel, 316 Stainless Steel, or Hastelloy. In some embodiments, the coil wraps around the tube with no effective spacing between each turn of the coil.

In some embodiments, a catalyst is impregnated on processing surfaces to provide intimate proximity between heated catalyst surfaces and chemical substrates. In some embodiments, an electric-to-heat conversion is highly efficient in a range between 85% to 95%. The magnetic induction heating may allow the system to tolerate stoppages of the flow of the material, thereby eliminating the need for a surge tank. The magnetic induction heating system may be implemented as an in-line heating device for product recirculated to surge tanks or other reprocessing streams. The system may be enclosed in an inert chamber for processing flammable or oxidation sensitive streams. Tube turn density, or coil proximity, or heat exchanger design can be manipulated to precisely deliver heat in any desired pattern along the processing line of the system.

Embodiments of the present disclosure provide a method for heating a mass comprising the steps of: introducing a material to a magnetic induction heating system via an inlet in a tube, the tube being surrounded by at least one coil, and the tube receiving at least one heat exchange element positioned within the tube; delivering an alternating current from a power source to the at least one coil; supplying current to the coil thereby inducing current in the heat exchange element to produce heat; which then flows into heating target through passive thermal diffusion.

Additional features and advantages of the disclosed embodiments will be set forth in part in the description that follows, and in part will be apparent from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1 is a front view of an exemplary system, according to embodiments of the present disclosure.

FIG. 2 is a front view of an exemplary system, according to embodiments of the present disclosure.

FIG. 3A illustrates an exemplary heat exchange element according to embodiments of the present disclosure.

FIG. 3B illustrates an exemplary heat exchange element according to embodiments of the present disclosure.

FIG. 3C illustrates an exemplary heat exchange element according to embodiments of the present disclosure.

FIG. 3D illustrates an exemplary heat exchange element according to embodiments of the present disclosure.

FIG. 3E illustrates an exemplary heat exchange element according to embodiments of the present disclosure.

FIG. 3F illustrates an exemplary heat exchange element according to embodiments of the present disclosure.

FIG. 4 is a side view of an exemplary heat exchange element according to embodiments of the present disclosure.

FIG. 5 illustrates a graphical depiction of four times the skin depth and the percentage of heat loss to a 0.14 in tube wall versus the frequency, according to embodiments of the present disclosure.

FIG. 6 illustrates the fraction of heat produced in the HEX portion of a HEX-tube system for various tube diameters and frequencies.

FIG. 7 illustrates a graphical depiction of the percent wall coupling versus the frequency for various tube thicknesses and for frequencies between 0 and 500 kHz, according to embodiments of the present disclosure between 0 and 50 kHz

FIG. 8 illustrates a graphical depiction of the percent wall coupling versus the frequency, according to embodiments of the present disclosure.

FIG. 9 illustrates a graphical depiction of four times the skin depth versus the frequency, according to embodiments of the present disclosure between 0 and 12 kHz.

### DETAILED DESCRIPTION

Reference will now be made in detail to embodiments and aspects of the present disclosure, examples of which are illustrated in the accompanying drawings. Where possible, the same reference numbers will be used throughout the drawings to refer to the same or like parts.

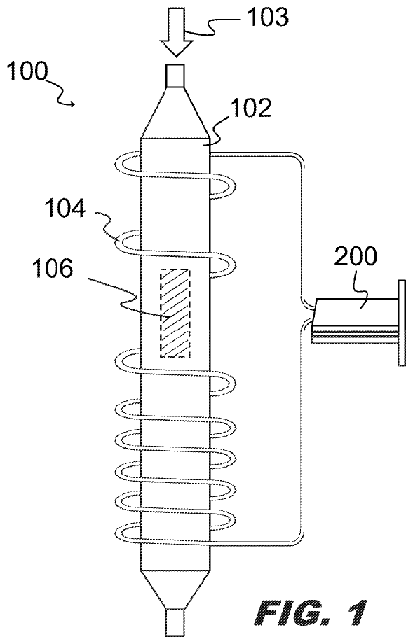

FIG. 1 is a front view of an exemplary system 100, according to embodiments of the present disclosure. System 100 may include one or more tubes 102 that may be configured to receive a material 103 that may be heated by system 100. In some embodiments, the one or more tubes 102 may be configured for fluid conveying of viscous materials through system 100. Tube 102 may be cylindrical in cross-sectional shape and may take any other suitable shape—Tube 102 may include any suitable material (e.g. 316-stainless steel, 304 stainless steel, Hastelloy, ceramic, glass, graphite, ferromagnetic steel, and other materials), may have an outer diameter (e.g. sixteen millimeters outer diameter), and an inner diameter (e.g. 1.5-inch inner diameter). The material 103 to be heated may be conveyed through the tube 102 via one or more pumps, gravity, or other means such as pulse-free pumps, reciprocating pumps, rotary pumps, impulse pumps, velocity pumps, etc.

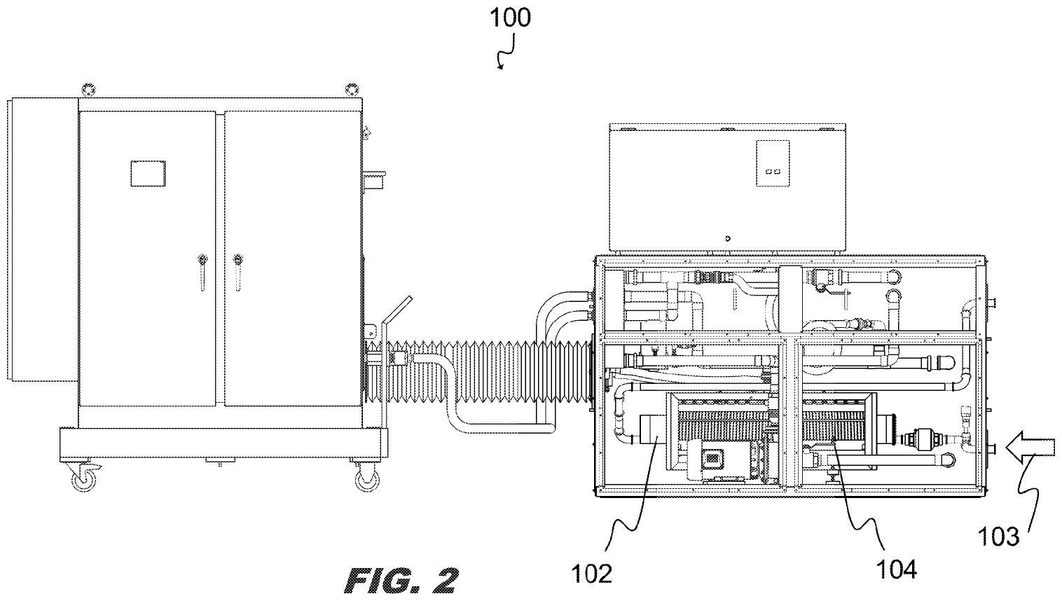

System 100 may further include an induction coil 104 that may be electrically insulated induction coil(s). The coil 104 may be wrapped around a length of the tube 102. In some embodiments, coil 104 may be wrapped around the tube 102 without effective gaps between the coil 104. “Without effective gaps” may refer to the coil 104 wrapping around the tube 102 such that no space or negligible space is present between winds of the coil 104 as illustrated in FIG. 2. The negligible space may be provided so that the coil 104 may have electrical insulation around each wind of the coil 104. Coil 104 may be tightly wound such that there is no effective space between turns of the coil 104 to confine flux so as to minimize proximity heating.

In an induction system 100 where no spacing exists and/or the coils 104 are arranged without effective gaps between coil turns along the tube 102 length, magnetic flux streamlines may concentrate in the area bounded by the coil 104 to form a parallel or nearly parallel bundle of flux lines from the top-to-the-bottom of the tube 102. Maxwell's equations predict that magnetic flux lines engage with metals to produce eddy currents at right angle to the flux. Therefore, any parallel flux streamlines can solely engage with the tube wall 102 at the tube flange lip or along the metal circumference of the tube 102. In general, the fraction of flux coupling with the conductor occurs according to the function sin θ, where θ is the smallest angle between the flux and the conductor surface. Therefore, θ is 0° for streamlines parallel to the tube sidewall with sin 0° being 0. Therefore, for tightly-wound coil 104, the metal flange ring and the thin metal perimeter wall may couple with flux at an optimal right angle. Therefore, tube-heating is minimized.

In contrast, magnetic flux lines for wide-spaced coil turns form a circular flux pattern around the conductor axis in accordance with Ampere's right-hand rule. Unlike the more parallel flux lines from tight-spaced coil 104, these circular flux lines penetrate the tube 102 surface at a variety of non-zero angles. Therefore, hot-spots increasingly develop as the θ for flux-coupling approaches 90°. This localized heating effect is called proximity heating and if unchecked, thermolabile materials will produce localized bake-on or fouling inside the tube at the point of maximum flux engagement.

System 100 may oscillate current supplied from a power source 200 back-and-forth in coil 104 between an inductance (L) and a capacitance (C). Coil 104 can be, for example, copper or silver, i.e. highly conductive with a relatively low self-heating. Coil 104 can be any length and diameter to conform to the process tube 102 so as to provide the desired inductance calculated in Equation (1), for example, two feet long and can have, for example, an inner diameter of two inches. Other materials and dimensions familiar to those of ordinary skill in the art may be used for a given use case.

Coil 104 is shown in an exemplary arrangement that can be used, but others are possible, depending on the geometry and arrangement of system 100. In some embodiments, a helical coil is used for the induction coil 104. In some embodiments, a non-helical coil might be used, which may include pancake coil, a butterfly coil, a hairpin coil or a slot coil, or any other suitable coil. In some embodiments, system 100 may implement more than one type of coil along different segments of tube 102. The tube 102 or conducting metal strip comprising the coil 104 may be electrically insulated from contiguous turns of coil 104 by a temperature tolerant material such as Teflon shrink tube, woven glass fiber cladding, or any other suitable temperature tolerant material. The tube 102 will likewise be electrically insulated from the coil 104.

In some embodiments, the turns of the coil 104 will be tightly wound around the electrically insulated process tube 102, so that, other than the insulation, no gaps exist between the turns of coil 104. The number of turns of coil 104 may be calculated to create the desired frequency in resonance with the selected capacitance using one of several equations. One such equation, for a helical coil is:

$$h = \frac{{r}^{2} \cdot {N}^{2}}{9 ( r ) + 10 ( L )} \qquad ( 1 )$$

Where: h=inductance in microhenry (pH); r=coil diameter in inches; N=number of turns; and L=length of the coil. However, alternative equations exist both for helical coils and for coils having other configurations.

In some embodiments, the coil 104 may have a provision for forced cooling. If the coil 104 is a tube, cooling water, glycol, or other cooling medium may be channeled through the tube. Alternatively, adjunct cooling structures may be used including heat exchange fins or other heat dissipating structures, fans, thermoelectric cooling devices, or surface-soldiered cooling-water tubes or channels, among other cooling mechanisms. In some embodiments, instead of cooling tubes or metal strips, Litz wire can be used with or without insertion into a flexible polymeric tube to provide cooling medium to cool the current carrying wire. In some embodiments, heat from the coil cooling medium may be used to preheat the processing stream material 103 prior to induction heating.

The coil 104 may take any suitable arrangement and may be varied for particular use-cases by changing one or more of the following properties of the coil: the number of turns, the length of the coil 104 bundle, and the diameter of the coil 104. In some embodiments, the diameter of the coil 104 may be adjusted based on the diameter of tube 102. In some embodiments, the turns of coil 104 may be fixed in size throughout system 100. In other embodiments, the turns of coil 104 may include various diameters and designs for targeted localized induction in system 100. For example, coil 104 may service several induction stages with variable coil configurations at each stage. The diameter of the coil turns may change along the length of the process tube 102 in order to provide variable localized regions of flux coupling with concomitant localized control over heat induction over various positions along the process tube 102. In some embodiments, coil 104 may service several tube 102 segments as shown in FIG. 2, with all segments or only some of the segments being energized by power source 200 at any given time.

Coil 104 properties may be adjusted to dictate the coil architecture to provide the ideal resonance frequency in an inductance-capacitance resonance circuit. In some embodiments, the circuit will provide provision for some in situ control over inductions and/or capacitance in order to provide fine tuning of the resonance frequency as described herein.

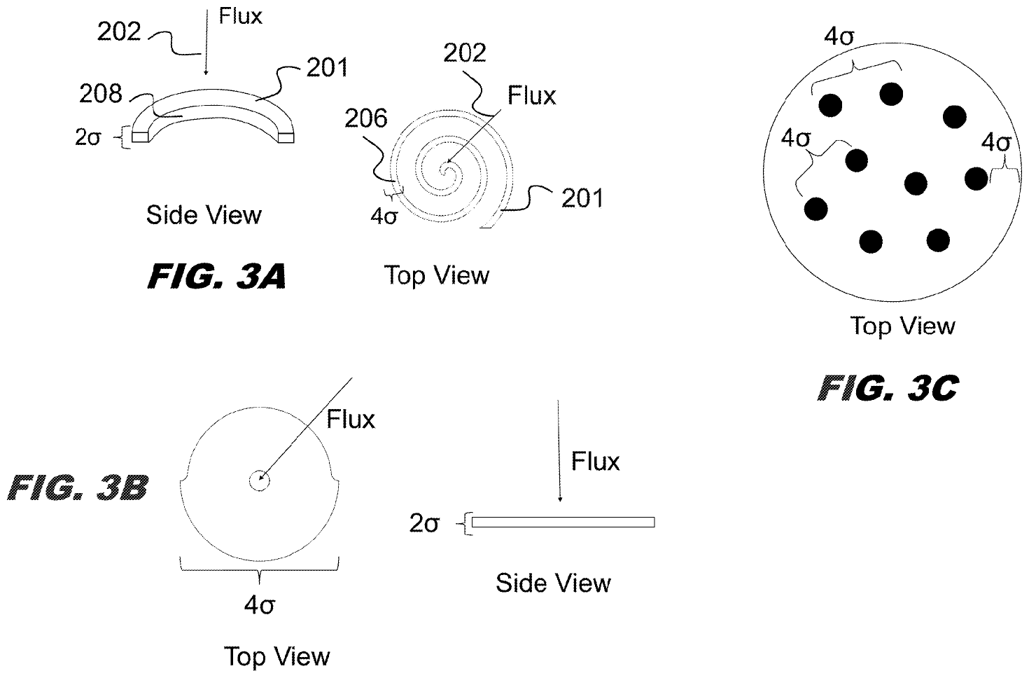

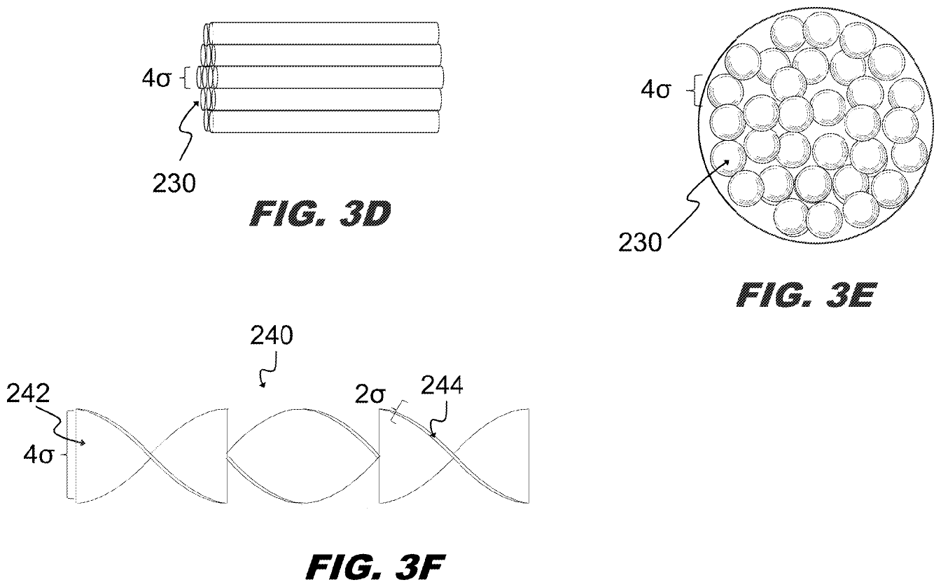

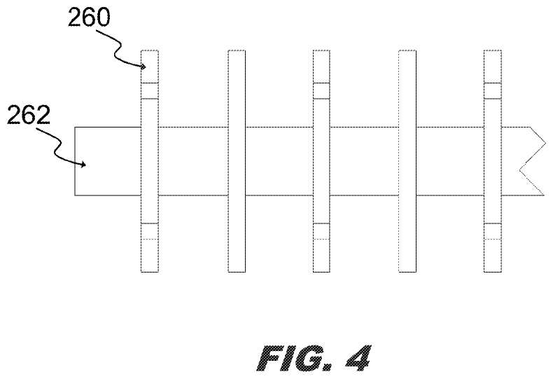

The resonance frequency may be selected such that the resulting skin depth largely ignores coupling in the wall of tube 102. The skin depth is that distance below the surface of a conductor where the current density has diminished to 1/e (e.g. 36.8%) of its value at the surface. Instead, the majority of the magnetic flux couples with surfaces of one or more heat exchange elements 106 positioned within tube 102. The heat exchange elements 106 and their respective geometries, shapes, and sizes are described in further detail below, for example, in reference to FIGS. 3A-3F.

The design of the internal heat exchange elements 106 depends on several properties of system 100. For example, the surface area of the heat exchange element 106 may depend on the thermal sensitivity of the material 103 and/or process stream. More particularly, the thermal sensitivity of material 103 may be the allowable temperature differential between the heat exchange element 106 surface and the material 103 (the delta T or A T). For mild allowable Δ T, heat must be distributed over a larger surface area, contributing to a larger surface area of an exemplary heat exchange element 106. A smaller heat exchange surface area may be suitable for thermally stable materials (e.g. water). Heat exchange element 106 can be formed to create an optimal and efficient coupling between heat exchange element 106 and an induced magnetic field. An efficient coupling provides for the highest interaction between the magnetic flux and heat exchange element 106.

Heat exchange element 106 can be separate from tube 102 and inserted inside tube 102 with no physical contact between coil 104 and heat exchange element 106. Heat exchange element 106 may be composed of several elements. One, some, or all of these elements will be susceptible to magnetic induction heating. Heat exchange element 106 can be, for example, solid and fixed, for example as a tube bundle (see e.g., FIG. 3D), or heat exchange element 106 can, for example, yield in some way to the flow of material 103, for example metal wools, ribbons of induction susceptible materials, springs, or propellers (see e.g., FIG. 3F).

The skin effect forces the inducted current to the outside of a conductor. High electrical resistance domains in the heat exchange (e.g. heat exchange element 106) disrupts the outward migration of electrons. IR heating may arise in the near vicinity of the high resistances. Placing high resistances at 4 skin depths away from each other may provide optimization of uniformity at the heat exchange surface. Similarly, a heat exchange element 106 two skin depths deep, where practical, provides a good tradeoff between heat generation and exchange. The heat exchange element 106 may be immobile, or it may rotate, or have other motion depending on the heat transfer demands of the process stream.

Heat exchange element 106 may be designed and positioned to optimize induction of system 100. For example, unlike DC current, AC current does not flow uniformly through a conducting wire. Instead, electrons flow through an outer skin layer of the conductor. Increasingly higher frequencies focus this skin layer ever closer to the periphery of the conductor. The inverse relationship between frequency (f) and skin depth (σ) is approximated by the formula:

$$σ = \sqrt{\frac{ρ}{{μ}_{r} \cdot f}} \cdot 1000 \qquad ( 2 )$$

Where: σ=1 skin depth (mm); ρ=Electrical Resistivity (μΩm); μᵣ=Relative Magnetic Permeability (1 for non-ferromagnetic metals such as 304 or 316 stainless steel); f=Frequency kHz.

Electron flow restricted to the skin layer produces localized IR heating within the skin region. Unaddressed, skin effect heating results in a heat exchange surface superheated at the outer margins with little heating near the center of the heat exchange element.

Thermally sensitive processing streams, including material 103 in some embodiments, may require uniform heat distribution across all heating surfaces (e.g., heat exchange element 106) in order to minimize fouling of material 103 at the circumferential fringe. The electrical phenomena responsible for the skin effect can be corralled by judiciously inserting high resistance obstructions at key positions along the heat exchange element 106. Extremely high resistance features introduced into the conductors may block the exodus of electrons migrating to the outer skin region. Increased IR heating occurs in the vicinity of electron barriers, and the strategic distribution of IR barriers allow for uniform or nearly uniform heat deposition over the heat exchange surface. IR-barriers may include slits, cutouts, holes, grooves, indentations or other current-impeding features in a heat exchange metal. Other resistance-altering structures such as dimples, mounds, wrinkles, spikes, partially penetrating holes or other similar structures might also be used.

In some embodiments, high resistance-barriers may bound regions. At a skin depth of 4σ, eddy currents generated in the bounded regions are largely free from self-cancellation. At less than 4σ depths the upward moving electrons on one side of the eddy partially cancel the downward electron flow on the opposite side of the eddy. At much beyond 4σ, outer hot and central cold regions become increasingly segregated. Similarly, a HEX surface thickness of up to 2.25 skin depths provides efficient heat exchange without significant stratified heating.

In some embodiments, the heat exchanger element 106 surface will be made of 304 Stainless Steel (SS), 316 SS, or Hastelloy, due to the established resistance of these metals to harsh processing environments. In other embodiments, the heat exchanger element 106 may include any conductor or semiconductor. For example. ferromagnetic metals heat especially well and influence the size of the skin layer through μᵣ in Equation (2). In some embodiments, heat exchanger element 106 may include a core of ferromagnetic metal clad in a corrosion-resistant alloy or other material. Additionally, dielectric support materials such as ceramics might be coated with metals or other conductors or semi-conductors and be used alone or in combination with other heat exchange surfaces to provide ideal heating from heat exchanger element 106.

System 100 may implement a different heat exchange element 106 based on the material 103 input into system 100. For example, some process streams are thermally sensitive while others tolerate heat well. To optimize system 100, the product-allowable ΔT of the process should be determined, where the ΔT is the temperature between the heated stream 103 and the induction-heated heat exchange element 106. The required surface area for a given ΔT can be calculated by the equation:

$$A = \frac{q}{U \cdot Δ T} \qquad ( 3 )$$

Where: A=the heat exchange surface area demanded by the process (m²); q=the maximum power delivered to the system (Watts=J/sec); ΔT=the user-selected allowable temperature (° C.) difference between heat exchange surface and the material 103; U=is the universal heat transfer coefficient of the system (J/(m²·° C.)).

The universal heat transfer coefficient reflects the sum of all heat transfer resistances in the system. For example, for a simple heating system comprised of a process stream uniform in all properties and flowing through a simple tube, the value of U may be composed of:

$$\frac{1}{U} = \frac{A}{{h}_{film \cdot A}} + \frac{x}{{k}_{ss}} + \frac{A}{{h}_{food}} \qquad ( 4 )$$

Where: A=the heat transfer area calculated from Eq (3)(m²); X=the thickness of the heat exchange metal comprising the tube (m); k=thermal conductivity of the heat exchange metal (W/m·° C.); h=the film coefficient, the resistance to thermal diffusion posed by the process stream (W/m²·° C.).

In some embodiments, “h” may be determined through direct experimentation. In other embodiments, equations may be used to calculate “h” for certain simple heat exchanger geometries such as tube flow:

$$h = \frac{k \cdot {Nu}_{turb}}{D} \qquad ( 5 )$$

Where for turbulent flow: k=the thermal conductivity of the fluid (W/m·° C.); D=the diameter of the tube in meters (m).

And for laminar fluids as:

$$h = Nu \cdot \frac{6.8 W}{{m}^{2} \cdot ° C .} \qquad ( 6 )$$

Where the Nusselt number in Eq(5) and Eq(6) can be calculated as:

For turbulent flow:

$$Nu = 1.86 {( Re \cdot 4.85 \cdot ( \frac{D}{L} ) )}^{\frac{1}{3}} \qquad ( 7 )$$

For laminar flow:

Nu=0.04324·Re^{0.8} (8)

D=the diameter of the tube in meters (m); L=is the tube length (m).

Equation (6) and Equation (7) depend on the Reynolds number, a unitless value that reflects the degree of turbulence in the flow stream.

$$Re = \frac{ρ \cdot u \cdot L}{μ} \qquad ( 9 )$$

Where: Re=the Reynolds number, a unitless expression of turbulence; ρ=density kg/m³; u=the linear velocity of fluid moving through the process tube in m/sec; L=the length of the tube; μ=viscosity kg/m·sec=(cps·1000).

Equations 5-9 may model heat exchange through an unobstructed uniform tube, which may not always be the case in all use-cases. An advantage of magnetic induction heating is its ability to heat densely packed or tortuous channels capable of inducing an exceptional level of turbulence or a high degree of intimacy with the heat exchange surface. Equations 5-9 provide a useful approximation for “h”, and therefore “U” determination. The equations suggest that U ultimately is increased by a high Reynolds number (Equations 7-8), resulting from a large linear velocity (Equation 9) and a small gap between heat exchange surfaces (Equation 5). The tight packing of heat exchange elements in magnetic induction increases heat transfer parameters compared to steam and allows for compact heating systems compared to steam-heated systems.

Therefore, the step-by-step process first decides the tolerable ΔT for the process based on material 103. The value of U (universal heat transfer coefficient of the system) is then determined by experimentation or approximated through using Equations 3-8. Based on the calculated U, Equation 2 provides the surface area that suitably distributes power “q” over the heat exchanger so as not to exceed the selected ΔT at the processing surface.

A magnetic induction resonance frequency is selected so that, to the extent possible, the ΔT between the tube wall 102 and material 103 is similar to the ΔT between the heat exchange element(s) 106 and the flow stream.

FIGS. 3A-3F illustrate exemplary heat exchange patterns that may be implemented as heat exchange element 106 in system 100, according to embodiments of the present disclosure. In some embodiments, the width of the heat exchange element 106 (i.e. the portion first encountering magnetic flux) may be about 4 skin depths. The thickness of the heat exchange element 106 (i.e. the portion parallel to the flux) may be at least 2 skin depths.

FIGS. 3A-3F illustrate various embodiments of heat exchange subunits constructed to provide 4 skin depths (σ) width and, where possible, 2.25 skin depths (2.25 σ) in thickness to provide optimal eddy-current-to-heat conversion efficiency and optimal heat transfer uniformity. In other embodiments, the heat exchange element may provide other skin depth widths and thicknesses such as a width between 1 and 10 skin depths and a thickness between 1 and 10 skin depths.

For example, FIG. 3A illustrates a spiral 200 that may be implemented as heat exchange element 106. Spiral 200 may be arranged at right angles to the magnetic flux streamlines (e.g. streamline 202). The width 206 of the turns of spiral 200 should be greater than or equal to 4σ across and distance between the top and bottom (i.e. the thickness 208) of the spiral 200 disk should be greater than or equal to 2σ in depth.

FIG. 3B illustrates another embodiment where a waffle disk 210 may be implemented as heat exchange element 106. The waffle disk 210 may be designed such that a width 212 between the lateral structural elements 214 may be 4σ. The top to bottom thickness 216 of waffle disk 210 may be up to 2σ.

FIG. 3C illustrates a perforated disk 220 that may be implemented as heat exchange element 106. Perforated disk 220 may include holes 222 that may be separated by 4σ while the gauge-thickness of the perforated disk 220 may be greater than or equal to 2σ.

FIGS. 3D and 3E illustrate further exemplary embodiments of possible heat exchange elements 106 having a plurality of channels 230 that allow adequate flow and intimate contact between material 103 and heat exchange element 106. The plurality of channels 230 may be separated by 4σ.

FIG. 3F illustrates a rotatable heat exchange element 240, that may include a width 242 of 4σ and a thickness 244 of 2σ.

Other embodiments of heat exchange elements are provided. For example, the heat exchange element may include ball bearings, propellers, screens, etc. In some embodiments, the heat exchange element may provide a geometry that allows easy cleanability.

Heat exchange element 106 can be made to rotate either passively through hydrodynamic pressure or through attachment (for example through a central axle, see FIG. 4) to a motor. Rotation may increase the universal heat transfer coefficient of the system (U) and can assist advancement of (especially viscous) streams through the process tube 102. For example, FIG. 4 illustrates a stack of heat exchanger plates 260 fixed along a central axis 262. The central shaft attaches to a motor (not shown) to rotate the plate assembly to increase heat transfer and to lift product as an aid to pumping.

Heat exchange elements 106 need not be uniform in mass, design, or spacing. Such attributes may be modified to provide some preferred localized custom heating profile. Heat exchange elements 106 may be plates, spheres, or any other configuration that allows suitable surface area for an acceptable ΔT while still allowing uniform stream flow past heat exchange elements 106. The heat exchange surface may be coated, plated, or impregnated with catalytic features that may be organic, inorganic, or a combination or both organic and inorganic compounds or elements. Similarly, heating surfaces may be developed as electrodes to participate in electrochemical reactions.

Various shields, flux concentrators and/or susceptors might be used to optimize heat exchange both within the flow stream and for the coil-tube assembly outside the tube 102.

System 100 may heat a material 103, and may include the tube 102, the coil 104, the heat exchange element 106, and power source 200 delivering an alternating current to coil 104. The alternating current can induce a current in the in the heat exchange element 106 to produce heat that can heat material 103.

Now that the components of system 100 have been described in detail, the operation of system 100 can be better understood. As shown in FIGS. 1 and 2, material 103 (e.g. cold liquid, gas, or solid) enters tube 102 at the heating portion of system 100. The heating portion can include tube 102 which can be, but is not limited to being made of a dielectric material. Inside tube 102 is heat exchange element 106. Tube 102 and heat exchange element 106 are positioned inside coil 104 which is hollow to accommodate water cooling. Material 103 enters system 100 and is transported by a pump through tube 102 containing heat exchange element 106 which has been heated by induction. Material 103 is heated by passive thermal transfer from the inductively heated, heat exchange element 106.

Induction coil 104 can be connected to, for example, a high energy LC (inductance-capacitance) resonance circuit. Resonance generates magnetic flux in coil 104. The flux couples with heat exchange element 106 to generate heat. Heat generated in heat exchange element 106 is then transferred to material 103 by passive thermal diffusion.

Material 103 flows through system 100 by a means of conveyance such as, but not limited to, pumping, gravity feeding, augurs, belts, and coverers. Highest electric-power-to-mass heating efficiency may occur when material 103 is preheated in the pre-induction stage with thermal energy reclaimed from heated material 103 exiting the induction stage, from heat generated in electronics 200, and from heat generated in coil 104. Material 103 passes from the pre-heating stage (when used) to the induction stage. Heat exchange element 106 boosts preheated product to the desired temperature using magnetic induction heating. As material 103 flows past heat exchange element 106, heat is transferred from heat exchange element 106 to material 103. The temperature of heated material 103 exiting heat exchange element 106 is monitored by, for example, by a thermocouple, temperature sensor, or another measuring device. If the temperature is too hot, power to coil 104 is reduced by automated control provided as part of feedback circuit of the magnetic induction unit. Similarly, if the temperature falls below a preselected setpoint, the power to coil 104 is increased and temperature is increased. The rate of temperature adjustment and precision of the endpoint temperature can depend on both the sensitivity of the temperature measuring device and the induction circuit. Magnetic induction heating can be automatically controlled by electronics. Heated material 103 exits the induction stage and, depending on the requirements of the material, can be cooled by thermal reclamation, by flash cooling, by simple passive exchange with the surrounding environment, or by some other suitable cooling process which can provide optimal post-heating handling of the heated material 103. The induction field is supplied by induction coil 104 surrounding tube 102 which houses heat exchange element 106, or by tube 102 if tube 102 also serves as heat exchange element 106.

In some embodiments, magnetic induction may achieve full power output instantaneously. Consequently, a magnetic induction heating system (e.g. system 100) can achieve processing targets within a few seconds when required. Early-generated heat may be lost to bringing cold metal heat exchange surfaces (e.g. heat exchange element 106) up to the target processing temperature. However, the heat sink properties of the metal heat exchange surfaces provide thermal capabilities unattainable by steam heating systems.

A process that may include slow-and-steady heat delivery can use high-mass heat exchange elements to provide greater inertia to temperature change. In contrast, low mass heat exchange elements of a comparable surface area would instead provide nimble response to flow or temperature change with rapid attainment of processing goals, but perhaps at the expense of greater heat variation of the heat exchange surface. Many hybrid variations are possible. High mass elements might provide high inertia to temperature change early in the flow stream while a small heat exchanger end-portion composed of low mass end-elements provide rapid temperature correction against a relatively stable thermal background.

The architecture of heat exchange elements may vary by size, design, mass, or metallic properties within a single heat exchange stage to reflect a variety of spacings or heat exchange elements such as those shown in FIGS. 3A-3F.

This unprecedented temperature management of magnetic induction permits a variety of user-selected temperature profiles along the length of the heat exchange element 106. For example, the dense packing of early heat exchange elements allows rapid heating of cold product before the higher and potentially more damaging end-temperatures are encountered. A low flux-coupling configuration in the temperature sensitive final portion of the tube 102 would similarly protect thermally sensitive materials from thermal deterioration. For example, for a material with a desirable exit temperature less than 2° C. relative to the heating surface, system 100 may implement tight coil 104 turns with close coupling for the first two-thirds of heat exchanger 106 and have a ΔT of 30° C. The last one-third would have wider turns of coil 104 and/or looser turns to deliver gentler heat needed to achieve the exit ΔT of 2° C. desired by the process.

By strategic stacking of heat exchange elements 106 being mindful to prevent hot spots or difficult cleaning surfaces, a variety of combinations of heating rates along the process tube can achieved.

The process tube 102 may be composed of a dielectric material making it free from heating by magnetic flux. However, when a metal tube is used, magnetic flux may not only couple desirably with internal heat exchange elements, but it also couples with the metal tube 102 conveying the process stream. Careful resonance frequency selection creates a skin depth that minimally couples with the tube wall 102. In some embodiments, the system 100 may be utilized to calculate a resonance frequency with the same W/m² flux coupling at the tube wall 102 as the W/m2 in the principal heat exchange elements 106. As a result, the tube 102 wall becomes a heat exchange surfaces having matching heat transfer characteristics to the primary heat exchange surfaces 106.

Calculation of a target resonance frequency may include proper matching of capacitance and inductance through the following formulae.

$$f = \frac{1}{2 π \sqrt{L \cdot C}} \qquad ( 10 )$$

Where: f=Frequency (Hz), L=Inductance (Henrys), C=Capacitance (Farads). It therefore follows that:

$$L = \frac{1}{4 {π}^{2} {f}^{2} \cdot C} \qquad ( 11 )$$

$$C = \frac{1}{4 {π}^{2} {f}^{2} \cdot L} \qquad ( 12 )$$

In some embodiments, an induction power unit may have a fixed capacitance. Therefore, once a desired frequency is selected, Equation (11) may be solved to calculate the matching inductance. The number of coil turns required to provide the necessary inductance can be determined through Equation (1).

In some embodiments, magnetic flux can be disproportionately applied along the heating tube 102 to precisely dictate the amount of heat supplied to some subsection of a surface by modifying the turn-density or by providing tighter-or-looser coupling of the coil with the transfer tube in one region of the tube versus another. Flux shields or concentrations, such as metal or ferrite arches straddling the coil at points where flux needs concentration or diverting may also be implemented in system 100. Power source 200 may deliver current in whole or in part to various coil 104 or portions of coil 104. A primary coil 104 can also be inductively coupled with other coils to apply heat to areas difficult to reach via a primary coil 104.

Control systems for system 100 may include using sensors in-line with the process stream to feed data to a control module that changes power output by power source 200 based on sensor readings. Sensors can include temperature sensors at the inlet and/or outlet of the system, as well as sensors measuring or sensing flow, pressure, or rheological parameters of the flow stream. Inputs to the control modules can include sensor data from processes upstream or downstream of the heating system, including the electrical grid, energy storage devices, central control system for a processing or production line, or other streams of data that are able to be paired with a control algorithm to control system output or the speed of process stream flowing through the heating system 100. Operator input data to the control system can include, but is not limited to, process stream temperature setpoint, or percentage of unit output power (% output), or automatic PID control settings, or user defined PID control settings for the P, I, and D functions.

A control system can be used to increase the operating safety of the equipment. The control system can be programmed to shut off the system or provide zero or near-zero output power to the coil 104 under certain operating parameters, including data from a pressure, temperature, or flow sensor reading above or below a user-defined threshold. This control system can also include operator controls for emergency stop. The control system can also be programmed for a safety interlock that prevents more than a user-defined percentage of the maximum amps from going into the system for a given period of time to prevent overheating or runaway heating in the event of a sensor failure or other control system failure. Coil and all electronics are insulted against electric shock. For toxic or flammable process streams, the induction unit can be housed in an inert environment cabinet or other closure.

In some embodiments, system 100 may provide magnetic induction's rapid on-off capability that allows the temperature to be maintained in production lines holding transiently stalled product. Flow disruption might be planned such as a pause between filling shots delivered to unit-fill container, or they can be unexpected, such a line pause due to some process deviation. A PID or similar temperature control device senses in-line temperature and precisely meters induction energy into the stagnant stream. This differs from slow-responding steam heating systems because matter in steam-heated systems must remain mobile in order to prevent fouling or other thermal damage. To avoid thermal defects, steam systems typically require surge tanks or recirculation back to the source.

Alternatively, induction heating can reheat diverted product from a surge vessel or other product-routing source so that diverted product can be reintroduced into the process stream at the correct processing temperature. In some embodiments, it may be practical to wrap thermal heating tape around sections of the process line not addressed by the induction coil. Similar to coil-addressed portions of the line, temperature control of heat-taped lines can be PID controlled.

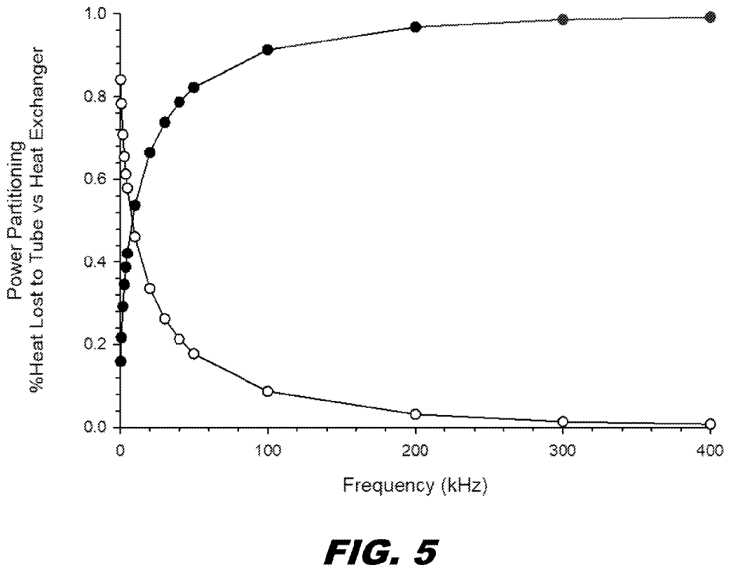

FIG. 5 illustrates a graphical depiction of four times the skin depth and the percentage of heat loss to the tube 102 versus the frequency, according to embodiments of the present disclosure. The graph shows the minimum heat exchange element 106 thickness (e.g. wire thickness or other heat deposition elements) needed for near 100% power deposition in a heat exchange element 106. In some embodiments with less than the minimum thickness, some energy may be cancelled-out as the two sides of the eddy current merge and cancel. Further, the line 300 shows the fraction of the power delivered to the system that will be deposited in standard 1.65 mm 316 SS tube thickness.

FIG. 5 reflects the degree of tube-coupling expected for various resonance frequencies for a 1.6 mm tube wall thickness. In the not-infrequent case when tube wall and main heat exchanger bundle cannot be matched, partial cooling by the cooled induction coil may be required to prevent overheating of the tube surface 102. When the tube 102 requires coil-cooling, regeneration of coil heat to preheat incoming cold product is recommended to retain maximum electric-to-heat magnetic induction efficiency.

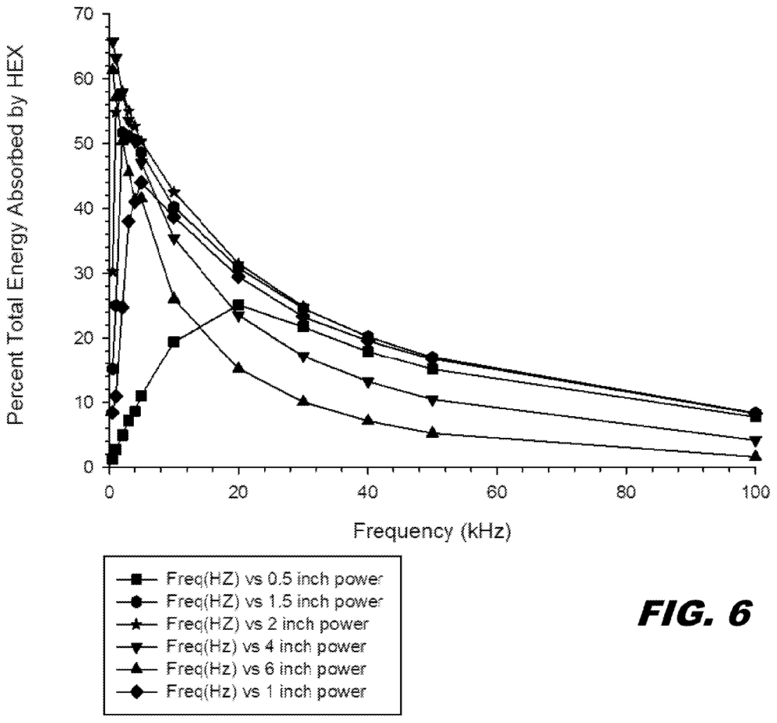

FIG. 6 illustrates a graphical depiction of the fraction of heat induced in the HEX portion of a HEX-tube system for various tube diameters and resonance frequencies.

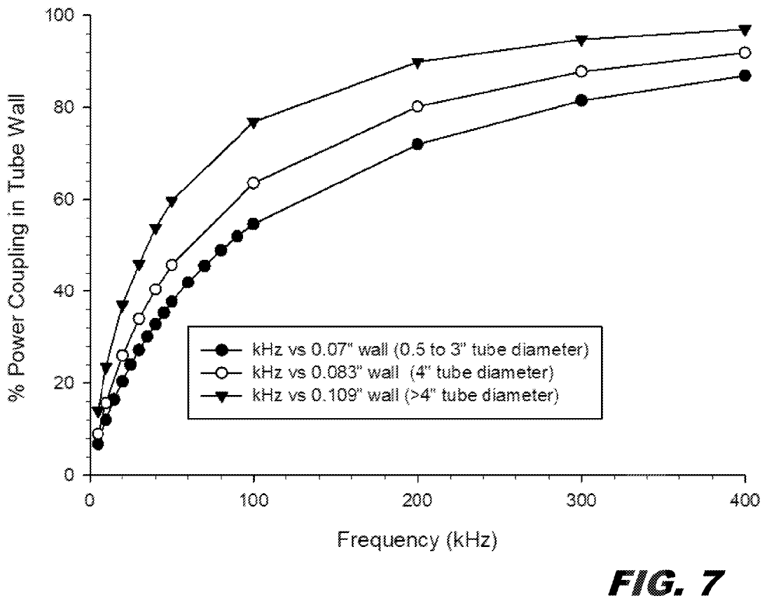

FIG. 7 illustrates a graphical depiction of the percent wall (e.g. tube wall 102) coupling versus the frequency, according to embodiments of the present disclosure. Three different wall thicknesses ranges are plotted in with associated tube diameters.

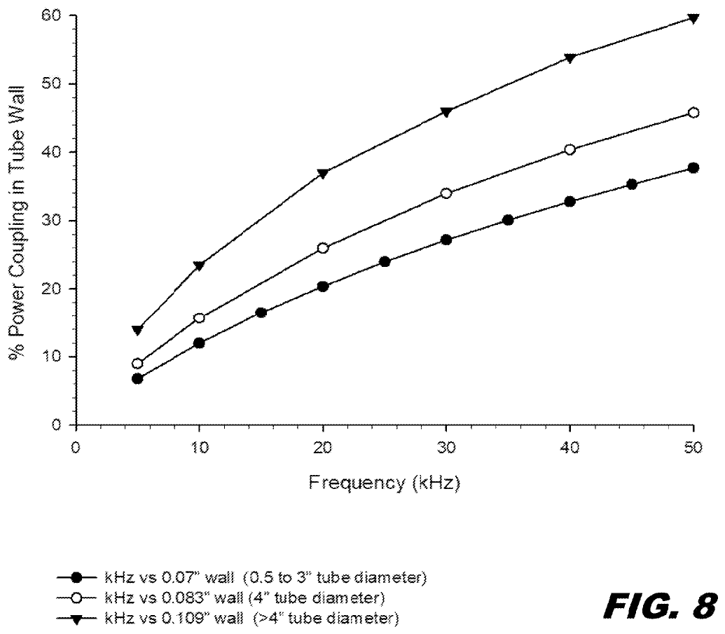

FIG. 8 illustrates a graphical depiction of the percent wall coupling versus the frequency, according to embodiments of the present disclosure. FIG. 8 reflects a lower frequency range of the graph of FIG. 7 for frequencies <50 kHz.

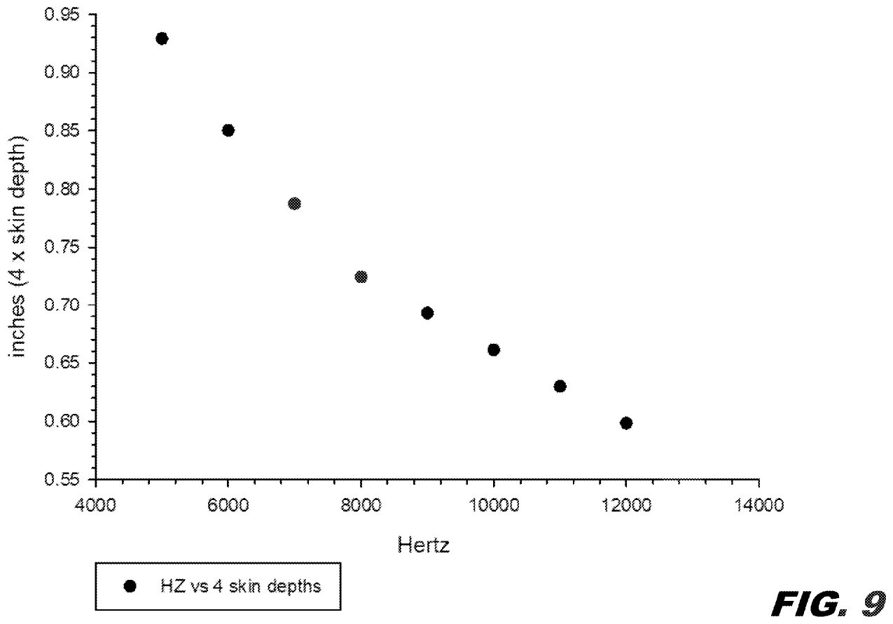

FIG. 9 illustrates a graphical depiction of four times the skin depth versus the frequency, according to embodiments of the present disclosure.

System 100 may provide magnetic induction that provides many approaches for tailor-crafting the thermal experience of the material 103. These include variations in coil 104 arrangement, coupling, and coil inductance. Internal heat exchange elements 106 can customized by metal type, surface area distribution, skin depth control, by number, and by geometric design. Magnetic induction's rapid feedback response to temperature permits temperature maintenance in a slowed or stalled process line, eliminating the need for a surge tank or recirculation. If recirculation is required, induction can make-up heat lost either alone or coupled with resistance heaters during stalled stages of production.

The entire system 100 or system components may be contained in an air-tight, purged enclosures or cabinetry used to enclose or shield such devices. The entire system 100 or components thereof may be contained in an enclosure with a degree of ingress protection that prevents water from entering the system while receiving direct spray from a water stream. The entire system 100 or components thereof may be contained in an enclosure that prevents dust, debris, dirt, and water from indirectly entering the system. The entire system 100 may have access panels as part of the enclosure to allow for equipment maintenance. Access panels may be equipped with sensors and locks to prevent them from being locked while the equipment is operating.

The system 100 may have flow connections and tubing appropriate for supplying a cooling media to remove waste heat from the coil and power electronics. The system 100 may have provision for cooling or waste heat remediation via a chiller or cooler mounted on the equipment skid or adjacent to the equipment skid. The system 100 may have provision for heat exchanger or heat exchangers that allow a closed loop of cooling water or other cooling media to have heat removed from it via heat exchange with another cooling media.

In some embodiments, system 100 may contain two or more coils and/or heating zones and power supplies in order to deliver a wider range of functionality in a single skidded unit.

System 100 may be mounted on top of a frame or supportive structure and able to be moved via casters or lifted with a forklift or pallet jack, crane, or other similar device that lifts or moves the equipment using supportive structures, including weight-bearing eyelets or frame or housings.

System 100 may have a touch protection to reduce the likelihood of the equipment operator contacting a heated surface. Touch protection can include additional shielding, grates, or other means to prevent operator contact mounted on the exterior of the equipment enclosure.

In some embodiments, system 100 may include catalytic materials that may provide for chemical reactions within induction heating in system 100. For example, a heat exchange element (e.g., heat exchange element 106) and/or a plurality of heat exchange elements may include catalytic materials that allow optimized induction heating and provide desired catalytic reactions with process streams (e.g., material 103). In some embodiments, a catalyst may be impregnated on processing surfaces to provide intimate proximity between heated catalyst surfaces and chemical substrates. In some embodiments, the heat exchange element(s) may be surface treated, coated, electromagnetically plated, cladded, or otherwise covered with catalytic material(s). In other embodiments, the heat exchange element(s) may be manufactured from catalytic materials such that the heat exchange element is uniformly catalytic.

Some embodiments may provide heterogeneous catalysts including zeolites, alumina, higher-order oxides, graphitic carbon, transition metal oxides, metals such as Raney nickel for hydrogenation, and vanadium (V) oxide. Other embodiments may provide heterogeneous catalysts, homogeneous catalysts or electrocatalysts. In some embodiments, heat exchange element may be coated with or constructed from catalytic materials such as high purity iron, nickel, ferromagnetic metals, metal alloys, catalytic nickel alloy, among others.

In some embodiments, multiple zones of catalytic material may be implemented. For example, a first zone of catalytic material may be implemented upstream of a second zone. The first zone may include a first catalytic material that generates a reaction in the process stream. The second zone may be adjacent to or spaced apart from the first zone and may include the same catalytic material or a different catalytic material to produce a desired reaction. Any number of zones of catalytic material may be implemented to achieve a desirable reaction.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure (e.g., slitted apertures, apertures, perforations may be used interchangeably maintaining the true scope of the embodiments)

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A magnetic induction heating system comprising:
a tube having an inlet that receives a gaseous, fluid, or solid material;
at least one inductively-heated heat exchange element positioned within the tube;
at least one coil or other flux-inducing conductor wrapped around or otherwise addressing the tube;
a power source delivering an alternating current to the at least one coil at a frequency tailored to the architecture of the system and the process stream, with the alternating current inducing a current in the heat exchange element to produce heat, wherein the heat from the heat exchange element is transferred to the material in the process stream.

2. The magnetic induction heating system of claim 1 wherein system parameters are manipulated to process material of any thermal sensitivity.

3. The magnetic induction heating system of claim 1 wherein system parameters are manipulated to process any material capable of conveyance material and of any viscosity

4. The magnetic induction heating system of claim 1, wherein the coil has a plurality of adjustable parameters including the number of turns of the coil, the length of the coil bundle, the diameter of the coil, and the number of coils implemented in the system, wherein such parameters can be strategically designed for optimal system and process stream treatment.

5. The magnetic induction heating system of claim 1, wherein the heat exchange element is constructed to produce even heating by providing patterns containing a 4-skin depth (σ) width bounded by regions of high resistance

6. The magnetic induction heating system of claim 1, wherein the heat exchange element forms at least one of the following configurations: a spiral, a waffle disk, a perforated disk, or disks with other structures conforming to the 4-skin depth convention.

7. The magnetic induction heating system of claim 1, wherein the heat exchange element(s) is(are) moveable within the tube either by hydrodynamic forces or through mechanically induced agitation.

8. The magnetic induction heating system of claim 1, wherein the heat exchange element(s) rotate either by hydrodynamic forces or through mechanically induced agitation to increase heat exchange and, where needed, as an assist to transporting the process stream through the tube.

9. The magnetic induction heating system of claim 1, wherein the tube comprises 304 Stainless Steel.

10. The magnetic induction heating system of claim 1, wherein the tube comprises 316 Stainless Steel.

11. The magnetic induction heating system of claim 1, wherein the tube comprises Hastelloy.

12. The magnetic induction heating system of claim 1, wherein the coil wraps around the tube with no effective spacing between each turn of the coil.

13. A method for heating a mass comprising the steps of:
introducing a material to a magnetic induction heating system via an inlet in a tube, the tube being surrounded by at least one coil, and the tube receiving at least one heat exchange element positioned within the tube;
delivering an alternating current from a power source to the at least one coil;
inducing a current in between the coil and the heat exchange element to produce heat; and
heating the material with the heat.

14. The magnetic induction heating system of claim 1, wherein a catalyst is impregnated on processing surfaces to provide intimate proximity between heated catalyst surfaces and chemical substrates.

15. The magnetic induction heating system of claim 1, wherein an electric-to-heat conversion is highly efficient in a range between 85% to 95%.

16. The magnetic induction heating system of claim 1, wherein the magnetic induction heating allows the system to tolerate stoppages of the flow of the material, thereby eliminating the need for a surge tank.

17. The magnetic induction heating system of claim 1, wherein the magnetic induction heating system is implemented as an in-line heating device for product recirculated to surge tanks or other reprocessing streams.

18. The magnetic induction heating system of claim 1, wherein the system is enclosed in an inert chamber for processing flammable or oxidation sensitive streams.

19. The magnetic induction heating system of claim 1, wherein tube turn density, or coil proximity, or heat exchanger design can be manipulated to surgically distribute heat in any desired pattern along the processing line of the system.
